(19) United States
(12) Patent Application Publication
(10) Pub. No.: US 2012/0032984 A1
(43) Pub. Date: Feb. 9, 2012

(54) DATA BROWSING SYSTEMS AND METHODS WITH AT LEAST ONE SENSOR, AND COMPUTER PROGRAM PRODUCTS THEREOF

(75) Inventors: Mei-Jung Chen, Taipei Hsien (TW); Chao-Kuang Yang, Taipei Hsien (TW)

(73) Assignee: ACER INCORPORATED, Taipei Hsien (TW)

(21) Appl. No.: 13/185,886

(22) Filed: Jul. 19, 2011

(30) Foreign Application Priority Data
Aug. 3, 2010 (TW) 99125704

(51) Int. Cl. G06F 3/00; G06T 11/60

(52) U.S. Cl. 345/660; 345/156

(57) ABSTRACT

The present invention provides an embodiment of a data browsing system with at least one sensor, which is applied to an electronic device and includes a storage unit, a display unit, at least one sensor and a processing unit. The storage unit stores a plurality of data contents. The display unit displays a first data content of the plurality of data contents. The at least one sensor is arranged for detecting a first motion of the electronic device. The processing unit is arranged for displaying determining a second data content of the plurality of data contents according to the first motion of the electronic device and displaying the second data content on the display unit.

### CROSS REFERENCE TO RELATED APPLICATIONS

This Application claims priority of Taiwan Patent Application No. 99125704, filed on Aug. 3, 2010, the entirety of which is incorporated by reference herein.

### BACKGROUND OF THE INVENTION

1. Field of the Invention

The present invention relates to data browsing system and methods with at least one sensor, and in particular relates to data browsing system and methods adopted in an electronic device to browse data according to the detection result of at least one sensor.

2. Description of the Related Art

Recently, portable devices, such as mobile computers, mobile phones, smart phones, PDAs (Personal Digital Assistants), and eBook devices, have become more and more technically advanced and multifunctional. Due to increased convenience and functions of the devices, these devices have become basic life necessities.

Currently, a handheld device may be equipped with a touch-sensitive screen to display data and receive related input via the touch-sensitive screen. For example, when users browse an electronic book on an eBook device, they can input commands by performing contact and movements on the touch-sensitive screen through their fingers. The eBook device will turn the page in corresponding ways according to the commands.

The touch-sensitive screen gives users a different way to input commands when compared to traditional keyboards or a mouse, but requires more system resources (i.e. additional power) than traditional input devices. Therefore, the resource issue is in need of being solved, for electronic devices limited by system resources.

Presently, some electronic devices may be equipped with a sensor, like an image sensor, proximity sensor, motion detector, gravity sensor and/or water level sensor?. Therefore, how to efficiently use the sensors of electronic devices to execute applications may become one of the solutions to mitigate the resource issue.

### BRIEF SUMMARY OF THE INVENTION

A detailed description is given in the following embodiments with reference to the accompanying drawings.

The present invention provides an embodiment of a data browsing system with at least one sensor, which is applied to an electronic device and includes a storage unit, a display unit, at least one sensor and a processing unit. The storage unit is arranged for storing a plurality of data contents. The display unit is arranged for displaying a first data content of the plurality of data contents. The at least one sensor is arranged for detecting a first motion of the electronic device. The processing unit is arranged for determining a second data content of the plurality of data contents according to the first motion of the electronic device and displaying the second data content on the display unit.

The present invention provides an embodiment of a data browsing system with at least one sensor, which is applied to an electronic device and includes a storage unit, a display unit, at least one sensor and a processing unit. The storage unit stores data content. The display unit is arranged for displaying a data content. The at least one sensor is arranged for detecting a predetermined motion of the electronic device. The processing unit is arranged for determining a zooming ratio according to the predetermined motion of the electronic device, zooming in/out the data content according to the zooming ratio, and displaying the data zoomed data content on the display unit.

The present invention provides an embodiment of a data browsing method with at least one sensor, which is applied to an electronic device and includes displaying a first data content of a plurality of data contents; detecting a first motion of the electronic device by using at least one sensor; determining a second data content of the plurality of data contents according to the first motion of the electronic device; and displaying the second data content.

The present invention provides an embodiment of a data browsing method with at least one sensor, which is applied to an electronic device and includes: displaying a data content; detecting a predetermined motion of the electronic device by using the at least one sensor; determining a zooming ratio according to the predetermined motion; and zooming in/out the data content according to the zooming ratio and displaying the zoomed second data content.

### BRIEF DESCRIPTION OF THE DRAWINGS

The present invention can be more fully understood by reading the subsequent detailed description and examples with references made to the accompanying drawings, wherein:

FIG. 1 is a schematic diagram illustrating an embodiment of a data browsing system with at least one sensor of the invention;

FIG. 2 is a schematic diagram illustrating an embodiment of an electronic device of the invention;

FIGS. 3A-3D are schematic diagrams illustrating the tilt angles of the electronic device of the invention;

FIG. 4 is a flowchart of an embodiment of a data browsing method with at least one sensor of the invention;

FIG. 5 is a flowchart of another embodiment of a data browsing method with at least one sensor of the invention;

FIG. 6 is a schematic diagram illustrating an embodiment of data content of the invention; and

FIG. 7 is a flowchart of another embodiment of a data browsing method with at least one sensor of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

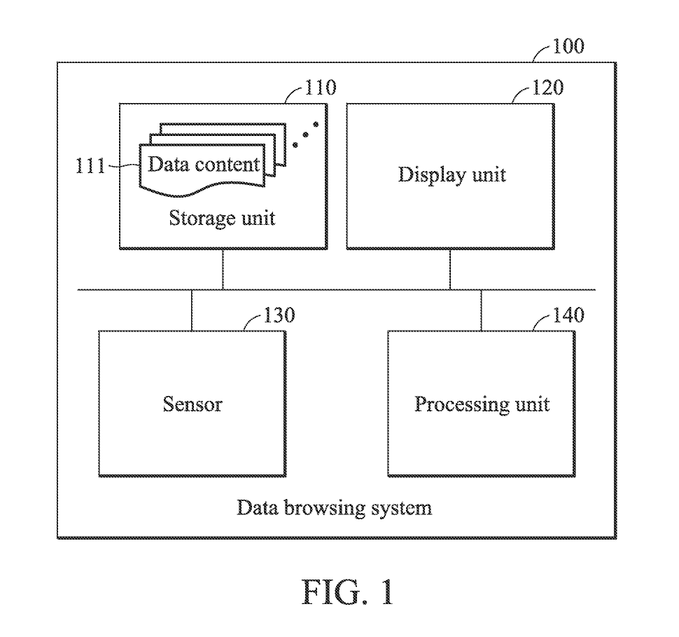

FIG. 1 is a schematic diagram illustrating an embodiment of a data browsing system with at least one sensor of the invention. The data browsing system 100 of the present embodiment can be applied to an electronic device, such as mobile computers, mobile phones, smart phones, PDAs (Personal Digital Assistants), and eBook devices.

The data browsing system 100 at least includes a storage unit 110, a display unit 120, at least one sensor 130 and a processing unit 140. The storage unit 110 includes a plurality of data contents 111. In some embodiments, the data contents 111 may be photos, contact information, eBook pages, multimedia contents, or other data items. The display unit 120 is arranged for displaying the data contents 111 and/or the associated interfaces stored in the storage unit 110. The sensor 130 can detect the motion of the electronic device 200. It should be noted that, in some embodiments, the sensor 130 can be an image sensor, a proximity sensor, a motion detector, a G sensor and/or a water level sensor, etc. The processing unit 140 executes the data browsing method with at least one sensor of the present invention according to the motion of the electronic device 200, the details of the processing unit 140 will be described in the following description.

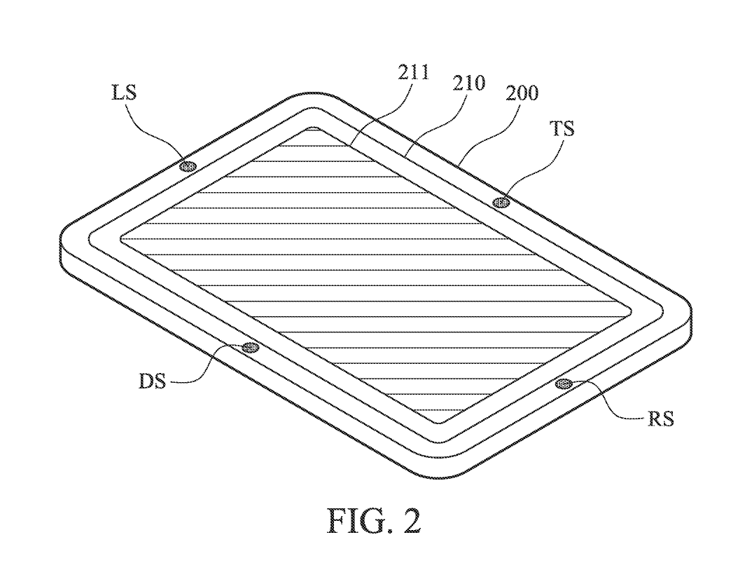

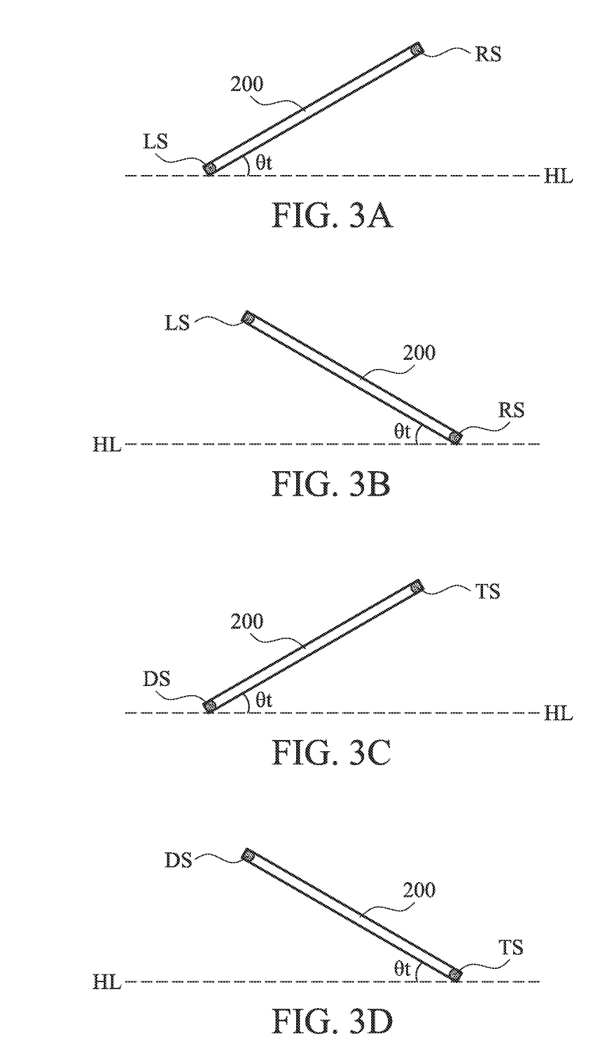

FIG. 2 is a schematic diagram illustrating an embodiment of an electronic device of the invention. As FIG. 2 shown, the electronic device 200 includes a data is arranged for displaying area 210 which is used to display the data content 211. The electronic device 200 includes a right side RS, a left side LS, a top side TS and a bottom side DS. As described above, the sensor 130 is arranged for detecting the motion of the electronic device 200. It should be noted that, in some embodiments, the motion of the electronic device 200 can be caused by the user holding the electronic device 200. For example, when a user raises the right side RS of the electronic device 200, a tilt angle θt between the horizontal tangent and the left side LS of the electronic device 200 is made, as FIG. 3A shows. When a user raises the left side LS of the electronic device 200, a tilt angle θt between the horizontal tangent and the right side RS of the electronic device 200 is made, as FIG. 3B shows. When a user raises the top side TS of the electronic device 200, a tilt angle θt between the horizontal tangent and the bottom side DS of the electronic device 200 is made, as FIG. 3C shows. When a user raises the bottom side DS of the electronic device 200, a tilt angle θt between the horizontal tangent and the top side TS of the electronic device 200 is made, as FIG. 3D shows. In addition, in some embodiments, the motion of the electronic device 200 can also be made back to the original position after raising one side (one of the right side RS, left side LS, top side TS and bottom side DS) of the electronic device 200. Moreover, in some embodiments, the motion of the electronic device 200 can also be away or close to the users themselves. It is noted that, the motions of the electronic device 200 are only examples of the present application, and the present invention is not limited thereto.

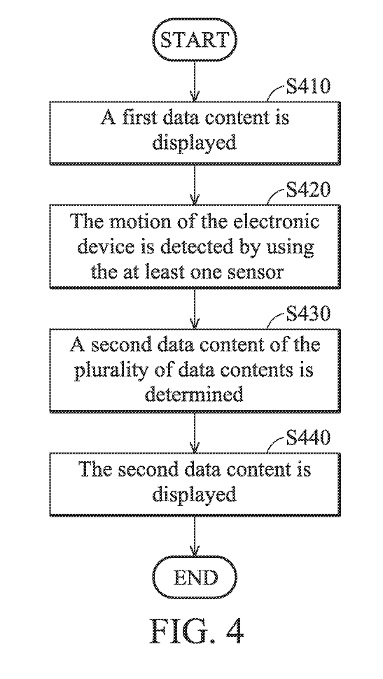

FIG. 4 is a flowchart of an embodiment of a data browsing method with at least one sensor of the invention. The data browsing method with at least one sensor of the present invention can be suitable for an electronic device, such as mobile computers, mobile phones, smart phones, PDAs (Personal Digital Assistants), and eBook devices.

In step S410, a first data content of a plurality of data contents 111 is displayed on the display unit 120. In the step S420, the motion of the electronic device 200 is detected by using the at least one sensor 130. In step S430, a second data content of the plurality of data contents 111 is determined according to the motion of the electronic device 200, and in step S440, the second data content is displayed on the display unit 120.

It should be noted that, in some embodiments, the sensor 130 is arranged for detecting at least one object, such as hands of the user. When the sensor 130 is arranged for detecting the at least one object, the process goes to step S420-S440 of the FIG. 4. For example, the electronic device 200 executes the related judgments and actions only when a user holds the electronic device 200.

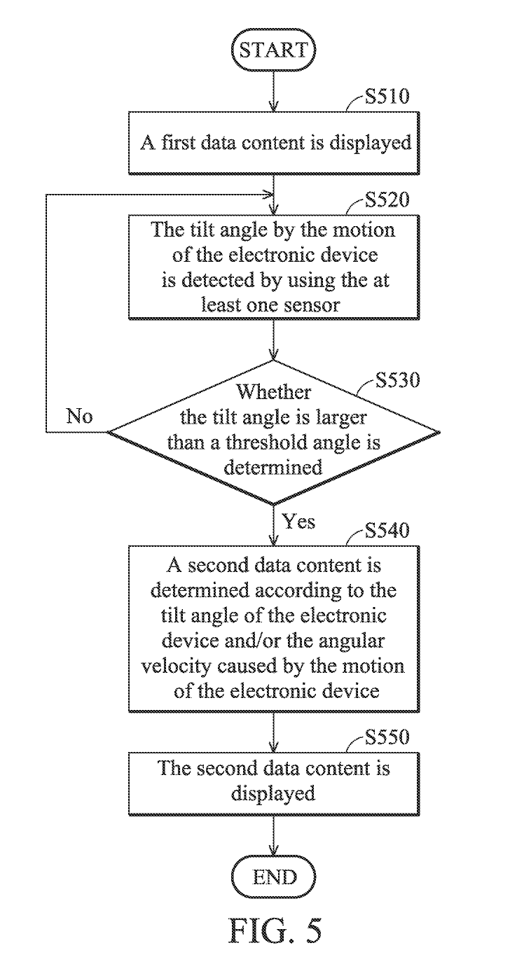

FIG. 5 is a flowchart of another embodiment of a data browsing method with at least one sensor of the invention. The data browsing method with at least one sensor of the present invention can be suitable for an electronic device, such as mobile computers, mobile phones, smart phones, PDAs (Personal Digital Assistants), and eBook devices.

In step S510, the display unit 120 is arranged for displaying a first data content of a plurality of data contents 111. In step S520, the tilt angle θt induced by the motion of the electronic device 200 is detected by using the at least one sensor 130. As described above, when one side of the electronic device 200 is raised, the tilt angle θt induced by the motion of the electronic device 200 is detected by the sensor 130. In step S530, whether the tilt angle θt is larger than a threshold angle is determined by the processing unit 140. When the tilt angle θt of the electronic device 200 is not larger than the threshold angle (No in step S530), the process goes to the step S520. When the tilt angle θt of the electronic device 200 is larger than the threshold angle (Yes in step S530), the process goes to step S540. In step S540, a second data content of the plurality of data contents 111 according to the tilt angle θt of the electronic device 200 and/or the angular velocity caused by the motion of the electronic device 200 is determined by the processing unit 140, and then the process goes to step S550. In step S550, the second data content is displayed on the display unit 120.

Similarly, in some embodiments, the sensor 130 is arranged for detecting at least one object, such as hands of the user. When sensor 130 is arranged for detecting that the at least one object exists, the process goes to step S520-S550 of the FIG. 5.

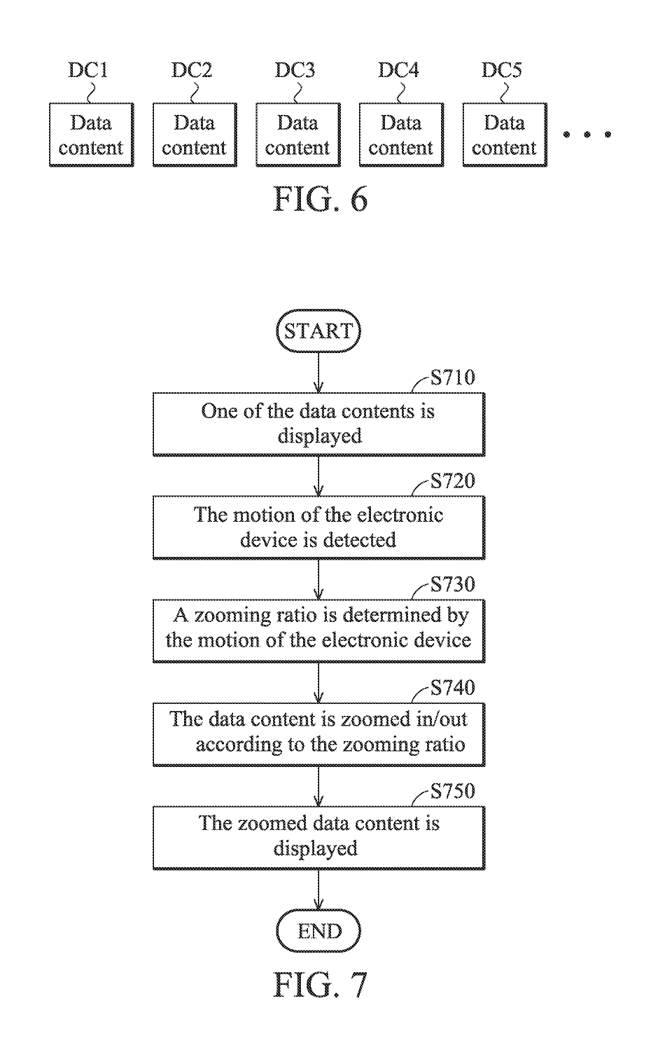

It should be noted that, when one side of the electronic device 200 is raised, the sensor 130 can detect the tilt angle θt and the angular velocity caused by the motion of the electronic device 200. In other words, the velocity of raising one side of the electronic device 200 will also be detected. In some embodiments, the data contents 111 can be arranged in accordance with a specific sequence, as FIG. 6 shows. The storage unit 110 comprises a plurality of data contents DC1˜DC5 arranged in accordance with a specific sequence. It should be noted that, in some embodiments, the processing unit 140 is arranged for determining the second data content of the plurality of data contents 111 according to the tilt angle θt. For example, the larger the tilt angle θt, the longer the distance between the first and second data content. In addition, in some embodiments, the processing unit 140 is arranged for determining the second data content according to the angular velocity, such as, when the angular velocity is higher, the distance between the first data content and second data content arranged in accordance with the specific sequence will be longer. For example, when the display unit 120 first displays the first data content which is data content DC1 when the sensor 130 detects that the motion of the electronic device 200 is raised to the right side RS and a low angular velocity is present during the rising motion, the processing unit 140 is arranged for determining that the data content DC2 is the second data content. Also, when the sensor 130 detects that the motion of the electronic device 200 is raised to the same right side RS and a high angular velocity is present during the rising motion, the processing unit 140 is arranged for determining that the data content DC4 is the second data content. Note that, in some embodiments, when data contents 111 is implemented by eBook pages, the motion of raising the right side RS of the electronic device 200 can represent a command of turning to a next page. When data contents 111 is implemented by eBook pages, the motion of raising the left side LS of a corresponding electronic device 200 can represent a command of turning to the front page.

In addition to the command of turning pages (turning to the next page and turning to the front page), in some embodiments, raising one side of the electronic device 200 can also execute some specific function. For example, the sensor 130 can detect whether the top side TS or bottom side DS of electronic device 200 is raised. When top side TS or bottom side DS of the electronic device 200 is raised and a specific tilt angle θt is produced, the processing unit 140 executes a specific function, such as a displaying setting adjustment and/or a displaying tag/note.

FIG. 7 is a flowchart of another embodiment of a data browsing method with at least one sensor of the invention. The data browsing method with at least one sensor of the present invention can be suitable for an electronic device, such as mobile computers, mobile phones, smart phones, PDAs (Personal Digital Assistants), and eBook devices.

In step S710, one of the data contents 111 is displayed on the display unit 120. In step S720, the motion of the electronic device 200 is detected by using sensor 130. In step S730, a zooming ratio is determined by the motion of the electronic device 200. In step S740, the data content according to the zooming ratio is zoomed in/out on the display unit 120. In step S750, the zoomed data content of the data contents 111 is displayed on the display unit 120 after zoomed in/out. It should be noted that, in some embodiments, the sensor 130 can be a proximity sensor used to detect the electronic device 200 and a specific object, such as a distance of a human face and electronic device 200, and the electronic device 200 can determine the zooming ratio according to the distance. For example, when the electronic device 200 is close to a human face, the display unit 120 is arranged for zooming in the data content, and when the electronic device 200 is moved away from the human face, the display unit 120 is arranged for zooming out the data content. Moreover, in some embodiments, the sensor 130 can be a G sensor and a motion sensor used to detect whether the user has removed the electronic device 200 away from the user themselves. Similarly, when the electronic device 200 is close to the user, the display unit 120 can zoom into the data content, and when the electronic device 200 is moved away from the user, the display unit 120 can zoom out from the data content.

It should be noted that, the embodiment of FIG. 7 can be combined with the embodiments of FIG. 4 or 5. In the other words, the motion of the electronic device 200 detected by the sensor 130 can control the electronic device 200 to turn pages, execute specific functions and zoom in/out.

Therefore, the data browsing system and methods with at least one sensor of the present invention adopted in the electronic device 200 browse data according to the detection result by the sensor 130, such that the data browsing system and methods with at least one sensor of the present invention provides a more convenient mechanism for data browsing and reduces related system resources, such as power, etc.

The data browsing system and methods with at least one sensor, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A data browsing system with at least one sensor, applied to an electronic device, comprising:
a storage unit, arranged for storing a plurality of data contents;
a display unit, arranged for displaying a first data content of the plurality of data contents;
at least one sensor, arranged for detecting a first motion of the electronic device; and
a processing unit, arranged for determining a second data content of the plurality of data contents according to the first motion of the electronic device and displaying the second data content on the display unit.

2. The data browsing system as claimed in claim 1, wherein the electronic device at least comprises a first side and a second side, and the first motion indicates that the first side or the second side of the electronic device is raised and a tilt angle is induced accordingly; wherein the first side or the second side is one of the right side, left side, top side, or bottom side of the electronic device.

3. The data browsing system as claimed in claim 2, wherein the first motion indicates that the first side or the second side of the electronic device is raised back to an original position.

4. The data browsing system as claimed in claim 2, wherein the processing unit is further arranged for determining whether the tilt angle is larger than a threshold angle, and when the tilt angle is larger than the threshold angle, the processing unit is further arranged for determining the second data content of the plurality of data contents and displaying the second data content on the display unit.

5. The data browsing system as claimed in claim 1, wherein the plurality of data contents is arranged in accordance with a specific sequence, the at least one sensor is further arranged for detecting an angular velocity caused by the first motion of the electronic device, and the processing unit is further arranged for determining the second data content of the plurality of data contents according to the angular velocity; wherein when the angular velocity is higher, a distance between the first data content and second data content arranged in accordance with the specific sequence is longer.

6. The data browsing system as claimed in claim 2, wherein the plurality of data contents is arranged in accordance with a specific sequence, and the processing unit is further arranged for determining the second data content of the plurality of data contents according to the tilt angle; wherein when the tilt angle is larger, a distance between the first data content and the second data content arranged in accordance with the specific sequence is longer.

7. The data browsing system as claimed in claim 2, wherein the electronic device further comprises a third side and a fourth side, the at least one sensor is further arranged for detecting a second motion of the electronic device, and the processing unit executes a specific function corresponding to the second motion; wherein the second motion indicates that the third side or the fourth side of the electronic device is raised and a specific tilt angle is induced accordingly; wherein the specific function is a display setting adjustment and/or a tag/annotation display function.

8. The data browsing system as claimed in claim 1, wherein the at least one sensor is further arranged for detecting a predetermined motion of the electronic device, the processing unit is further arranged for determining a zooming ratio according to the predetermined motion, and for zooming in/out the second data content according to the zooming ratio and displaying the zoomed second data content.

9. The data browsing system as claimed in claim 8, wherein the at least one sensor is further arranged for detecting a distance between a specific object and the electronic device, and the processing unit is further arranged for determining the zooming ratio according to the distance.

10. The data browsing system as claimed in claim 1, wherein the at least one sensor is further arranged for detecting whether at least one object exists; and when the at least one object is detected, the at least one sensor is further arranged for detecting the first motion of the electronic device, and the processing unit executes an application corresponding to the first motion.

11. A data browsing system with at least one sensor, applied to an electronic device, comprising:
a storage unit, arranged for storing a data content;
a display unit, arranged for displaying the data content;
at least one sensor, arranged for detecting a predetermined motion of the electronic device; and
a processing unit, arranged for determining a zooming ratio according to the predetermined motion of the electronic device, zooming in/out the data content according to the zooming ratio, and displaying the zoomed data content on the display unit.

12. The data browsing system as claimed in claim 11, wherein the at least one sensor is further arranged for detecting a distance between a specific object and the electronic device, and the processing unit is further arranged for determining the zooming ratio according to the distance.

13. A data browsing method with at least one sensor, applied to an electronic device, comprising:
displaying a first data content of a plurality of data contents;
detecting a first motion of the electronic device by using at least one sensor;
determining a second data content of the plurality of data contents according to the first motion of the electronic device; and
displaying the second data content.

14. The data browsing method as claimed in claim 13, wherein the electronic device at least comprises a first side and a second side, and the first motion indicates that the first side or the second side of the electronic device is raised and a tilt angle is induced accordingly; wherein the first side or the second side is one of the right side, left side, top side, or bottom side of the electronic device.

15. The data browsing method as claimed in claim 14, wherein the first motion indicates that the first side or the second side of the electronic device is raised back to an original position.

16. The data browsing method as claimed in claim 14, further comprising:
determining whether the tilt angle is larger than a threshold angle; and
when the tilt angle is larger than the threshold angle, determining the second data content of the plurality of data contents, and displaying the second data content.

17. The data browsing method as claimed in claim 13, wherein the plurality of data contents is arranged in accordance with a specific sequence, and the data browsing method further comprises:
detecting an angular velocity caused by the first motion of the electronic device by using the at least one sensor; and
determining the second data content of the plurality of data contents according to the angular velocity;
wherein when the angular velocity is higher, a distance between the first data content and the second data content arranged in accordance with the specific sequence is longer.

18. The data browsing method as claimed in claim 14, wherein the plurality of data contents is arranged in accordance with a specific sequence, and the data browsing method further comprises:
determining the second data content of the plurality of data contents according to the tilt angle;
wherein when the tilt angle is larger, a distance between the first data content and the second data content arranged in accordance with the specific sequence is longer.

19. The data browsing method as claimed in claim 14, wherein the electronic device further comprises a third side and a fourth side, and the data browsing method further comprises:
detecting a second motion of the electronic device by using the at least one sensor, wherein the second motion indicates that the third side or the fourth side of the electronic device is raised and a specific tilt angle is induced accordingly; and
executing a specific function corresponding to the second motion;
wherein the specific function is a display setting adjustment and/or a tag/annotation display function.

20. The data browsing method as claimed in claim 13, further comprising:
detecting a predetermined motion of the electronic device by using the at least one sensor;
determining a zooming ratio according to the predetermined motion; and
zooming in/out the second data content according to the zooming ratio, and displaying the zoomed second data content.

21. The data browsing method as claimed in claim 20, further comprising:
detecting a distance between a specific object and the electronic device by using the at least one sensor; and
determining the zooming ratio according to the distance.

22. The data browsing method as claimed in claim 13, further comprising:
detecting, by using the at least one sensor, whether at least one object exists; and
when the at least one object is detected by using the at least one sensor, using the at least one sensor to detect the first motion of the electronic device in order to execute an application corresponding to the first motion.

23. A data browsing method with at least one sensor, applied to an electronic device, comprising:
displaying a data content;
detecting a predetermined motion of the electronic device by using the at least one sensor;
determining a zooming ratio according to the predetermined motion; and
zooming in/out the data content according to the zooming ratio, and displaying the zoomed data content.

24. The data browsing method as claimed in claim 23, further comprising:
detecting a distance between a specific object and the electronic device by using the at least one sensor; and
determining the zooming ratio according to the distance.
